(19) United States
(12) Patent Application Publication
(10) Pub. No.: US 2023/0144278 A1
(43) Pub. Date: May 11, 2023

(54) POLYETHYLENE TEREPHTHALATE (PET) PARTICULATE COMPOSITION FOR STRUCTURAL CONSTRUCTION COMPONENTS

(71) Applicant: RJ Building Materials, LLC, Kansas City, MO (US)

(72) Inventors: Jason A. Morrill, Kearney, MO (US); Reda Ibrahim, Kansas City, MO (US)

(73) Assignee: RJ Building Materials, LLC, Kansas City, MO (US)

(21) Appl. No.: 18/054,613

(22) Filed: Nov. 11, 2022

Related U.S. Application Data
(60) Provisional application No. 63/278,310, filed on Nov. 11, 2021.

(51) Int. Cl. E04F 13/16; C09J 163/00; E04F 13/08

(52) U.S. Cl. CPC E04F 13/16; C09J 163/00; E04F 13/0885; E04F 13/0862

(57) ABSTRACT

A construction article comprising recycled plastic (e.g., polyethylene terephthalate) is provided. The plastic is preferably derived from post-consumer waste such as food or beverage containers. An adhesive network is created using an adhesive suitable for the chosen plastic(s), and pieces of the plastic are interspersed among that adhesive network in the final construction article. The construction articles are high strength, flame resistant, and water resistant and can be in the form of a sheathing panel, dimensional lumber, or other desired shape.

### CROSS-REFERENCE TO RELATED APPLICATIONS

The present application claims the priority benefit of U.S. Provisional Patent Application Ser. No. 63/278,310, filed Nov. 11, 2021, entitled POLYETHYLENE TEREPHTHALATE (PET) PARTICULATE COMPOSITION FOR STRUCTURAL CONSTRUCTION COMPONENTS, the entirety of which is incorporated by reference herein.

### BACKGROUND

### Field

The present disclosure broadly relates to construction materials and methods of producing those materials.

### Description of Related Art

Oriented Strand Board (OSB) is the most commonly used material in construction applications where panels and engineered beams are used is. OSB sheathing is commonly used in roofs, walls, flooring, and structural members such as engineered beams and joists. A typical installation of OSB in roof sheathing or exterior siding involves nailing the OSB to rafters, trusses, or studs, and then covering the installed OSB with a waterproofing layer such as tar paper, which is made by impregnating fiberglass or paper with tar. The tar paper is either nailed or stapled to the OSB, and then shingles are nailed on the tar paper. Though OSB sheathing and structural members possess the requisite strength for construction applications, it is prone to disintegration and rot when the integrity of the applied tar paper and shingles is compromised, such as by extreme weather events. In fact, the insurance industry estimates that in 2020 alone, 4,611 hailstorms affected 6.2 million properties and resulted in $14.2 billion in claims.

OSB panels coated with a moisture resistant lining have been used in an effort to minimize issues caused by exposure to moisture and microorganisms. These panels must be fastened to structural members using nails or screws, which provides an infiltration point for moisture and/or microorganism to get past the moisture resistant lining. The seams where individual OSB panels meet must be sealed, presenting another potential point of weakness for panels having a moisture resistant lining.

Another recent development is construction panels made from cellulose, low-density polyethylene, fiberglass, and aluminum. Cellulose, a major component of these panels, is vulnerable to degradation by moisture and microorganisms.

Plastic waste has been accumulating for more than 50 years. Plastic can be found in landfills and oceans, and even in the human blood stream in the form of microplastics. It is estimated that there are 10,000,000 tons of plastic land-filled annually in the United States. Large masses of plastic have formed islands in each of the world's oceans, some of which are as large as the state of Texas, or three times the size of France. The majority of these plastics are beverage containers, most commonly made from polyethylene terephthalate (PET) plastic.

### SUMMARY

The present disclosure is broadly concerned with a construction article comprising an adhesive network having pieces of plastic interspersed among the adhesive network.

A construction method is also provided, with the method comprising securing a construction article to a frame of a building. The construction article comprises an adhesive network having pieces of plastic interspersed among the adhesive network.

Finally, in another embodiment, the disclosure is directed toward a construction method comprising securing a construction article to a frame of a building. The construction article comprises an adhesive network having pieces of plastic interspersed among the adhesive network.

### BRIEF DESCRIPTION OF THE DRAWINGS

FIG. 1 is a perspective view of a construction article as described herein;

FIG. 2 is an end view of the construction article shown in FIG. 1;

FIG. 3 is a perspective view of an alternative embodiment of the construction article described herein;

FIG. 4 is a photograph showing test panels prepared as described herein;

FIG. 5 is a photograph of the testing and equipment setup for the strength testing, as described in Examples 4 and 9;

FIG. 6 is a photograph of a sample that was subject to workability testing, as described in Example 10; and

FIG. 7 is a graph of the mean burn time of each triplicate of samples subjected to flammability testing, as described in Example 11.

### DETAILED DESCRIPTION

The present disclosure is broadly concerned with environmentally friendly construction articles such as sheathing panels (interior and/or exterior), dimensional lumber, architectural features, and the like.

### COMPOSITION FOR FORMING CONSTRUCTION ARTICLE

The construction articles are formed from a composition comprising a plastic and an adhesive.

1. Plastic

While most any plastic is suitable for use in the disclosed construction articles, preferred plastics are commodity plastics such as those chosen from polyethylene terephthalate (PET), high-density polyethylene (HDPE), polyvinyl chloride (PVC), low-density polyethylene (LDPE), polypropylene (PP), polystyrene (PS), or mixtures thereof (i.e., two, three, four, five, or all six of the foregoing), with PET being a preferred plastic for use in the construction articles described herein.

Advantageously, the plastic preferably comprises a recycled plastic, and that recycled plastic can be obtained from either pre-consumer waste plastics, post-consumer waste plastics, or both. In a preferred embodiment, the plastic comprises PET container waste, e.g., water bottles, soft drink bottles, salad dressing bottles, cooking oil bottles, mouthwash bottles, shampoo bottles, liquid soap containers, or mixtures thereof.

In one embodiment, the composition used to form the building articles described herein comprises at least about 50% by weight waste plastics, preferably at least about 75% by weight waste plastics, more preferably at least about 95% by weight waste plastics, and even more preferably about 100% by weight waste plastics, based on the total weight of all plastics in the composition taken as 100% by weight. In another embodiment, these percentages are achieved with post-consumer waste plastics, and even more preferably with PET post-consumer (typically food or beverage) container waste.

In an alternative embodiment, the total plastic included in the composition used to form the building articles comprises less than about 50% by weight LDPE, preferably less than about 25% by weight LDPE, more preferably less than about 5% by weight LDPE, and even more preferably about 0% by weight LDPE.

The plastic can be provided in several physical forms, each preferably comprising discrete pieces. Examples of suitable physical forms include shreds, powders, pellets, or mixtures thereof. In one embodiment, the average maximum dimension of the plastic pieces included in the composition is less than about 10 mm, preferably less than about 8 mm, and more preferably less than about 6 mm. In another embodiment, the plastic is in shredded or pelleted form, and one or both of the average minimum dimension and/or average maximum dimension is about 2 mm to about 10 mm, preferably about 2 mm to about 8 mm, more preferably about 4 mm to about 8 mm, and even more preferably about 4 mm to about 6 mm. “Maximum dimension” and “minimum dimension” refer to the largest or smallest dimension, respectively, that exists on the particular plastic piece. Thus, for example, if the plastic is in the form of a strip, the maximum dimension would be its length, and the minimum dimension would be its thickness.

Regardless of the type of plastic and/or its physical form, the total quantity of plastic present in the composition used to form the disclosed building articles will generally be about 10% by weight to about 55% by weight, preferably about 15% by weight to about 50% by weight, more preferably about 15% by weight to about 50% by weight, and even more preferably about 20% to about 43% by weight, based on the total weight of all ingredients in the composition taken as 100% by weight.

2. Adhesive

Suitable adhesives include any that are capable of adhering to the chosen plastic. One preferred adhesive comprises a polymer such as an epoxy resin, with suitable epoxies for use in that adhesive including those chosen from epoxy novolac resins (e.g., bisphenol F epoxy novolac resins), bisphenol A epoxy resins (e.g., bisphenol A diglycidyl ether epoxy resins), or mixtures thereof.

A two-component epoxy adhesive is preferred, and the curing agent included in that system is selected based on the particular epoxy resin chosen, with amine curing agents being a preferred class of curing agents. Suitable amine curing agents include those chosen from aliphatic amines (e.g., poly(propylene glycol) bis(2-aminopropyl) ether, 1-piperazineethanamine), poly(amidoamines) (e.g., imidazoline polyamidoamine, or mixtures thereof.

Regardless of the adhesive utilized, it is preferred that the total adhesive (be it one-part of two-part) is present in the composition for forming the construction articles at a level of about 30% by weight to about 85% by weight, preferably about 40% by weight to about 80% by weight, more preferably about 40% by weight to about 80% by weight, and even more preferably about 45% to about 70% by weight, based on the total weight of all ingredients in the composition taken as 100% by weight.

In one embodiment, the weight ratio of total plastic to total adhesive is about 1:1 to about 1:3, preferably about 1:1 to about 1:2.7, more preferably about 1:1.1 to about 1:2.5, and even more preferably about 1:1.4 to about 1:2.2.

3. Flame Retardants

In some embodiments, the composition used to form the construction articles of this disclosure can further comprise a flame retardant. Suitable flame retardants include those chosen from metal hydroxides (e.g., magnesium hydroxide), halogenated compounds (e.g., halogenated epoxy resins, halogenated curing agents), phenolic microbubbles, organophosphorus compounds, or mixtures thereof.

When a flame retardant is included in the composition, it is preferably present at levels of about 0.5% by weight to about 6% by weight, preferably about 1% by weight to about 5.5% by weight, more preferably about 1.5% by weight to about 5% by weight, and even more preferably about 2% to about 4.5% by weight, based on the total weight of all ingredients in the composition taken as 100% by weight.

4. Filler

In some embodiments, the composition used to form the construction articles of this disclosure can further comprise a filler. Suitable fillers include those chosen from fumed silica, phenolic microbubbles, wood flour, or mixtures thereof.

When a filler is included in the composition, it is preferably present at levels of about 3% by weight to about 50% by weight, preferably about 4% by weight to about 45% by weight, and more preferably about 5% by weight to about 40% by weight, based on the total weight of all ingredients in the composition taken as 100% by weight.

It will be appreciated that the compositions can also include one or more optional ingredients, including those chosen from colorants (e.g., phenolic microbubbles), or mixtures thereof.

In one embodiment, the composition used to form the building articles comprises less than about 40% by weight cellulose, preferably less than about 20% by weight cellulose, more preferably less than about 5% by weight cellulose, and even more preferably about 0% by weight cellulose.

In another embodiment, the composition used to form the building articles comprises less than about 1% by weight fiberglass, preferably less than about 0.5% by weight fiberglass, and more preferably about 0% by weight fiberglass.

In one embodiment, the total combined weight of plastic and adhesive present in the composition is at least about 55% by weight, preferably at least about 75% by weight, more preferably at least about 85% by weight, even more preferably at least about 90% by weight, and most preferably at least about 95% by weight, based on the total weight of the composition taken as 100% by weight.

In a further embodiment, the total combined weights of PET plastic and adhesive present in the composition is at least about 55% by weight, preferably at least about 75% by weight, more preferably at least about 85% by weight, even more preferably at least about 90% by weight, and most preferably at least about 95% by weight, based on the total weight of the composition taken as 100% by weight.

In a yet further embodiment, the total combined weights of PET plastic, epoxy resin, and curing agent in the composition is at least about 55% by weight, preferably at least about 75% by weight, more preferably at least about 85% by weight, even more preferably at least about 90% by weight, and most preferably at least about 95% by weight, based on the total weight of the composition taken as 100% by weight.

In some embodiments, the composition consists essentially of, or consists of, a plastic(s), an adhesive(s), and one, two, or three of a flame retardant(s), filler(s), or colorant(s). Unless stated otherwise, “consisting essentially of a plastic(s)” and “consisting of a plastic(s)” are intended to encompass chemicals and/or modifying components that were inherently present in the plastic(s). For example, some recycled plastic may include plasticizers therein, such as those that might have been utilized at the time of original manufacture of the particular source of the plastic(s).

In another embodiment, the composition consists essentially of, or consists of, a plastic, an adhesive, and a filler.

In other embodiments, the composition consists essentially of, or consists of, PET plastic, an adhesive comprising an epoxy resin and a curing agent, and a filler.

In still other embodiments, the composition consists essentially of, or consists of, a plastic, an adhesive, and a flame retardant.

In other embodiments, the composition consists essentially of, or consists of, PET plastic, an adhesive comprising an epoxy resin and a curing agent, and a flame retardant.

In yet a further embodiment, the composition consists essentially of, or consists of, a plastic and an adhesive.

In another embodiment, the composition consists essentially of, or consists of, PET plastic and an adhesive comprising an epoxy resin and a curing agent.

### Method of Forming Construction Article

The method of forming the constructions articles comprises combining the plastic(s), adhesive(s), and any other ingredients and mixing for a sufficient time (e.g., at least about 2 minutes, preferably about 2 minutes to about 15 minutes) to create a substantially homogeneous mixture of those ingredients. In instances where a two-part adhesive is used, it is preferable to keep the resin component(s) separate from the curing agent(s) until just before pressing/molding in order to avoid premature curing of the material. In those instances, any other ingredients can first be mixed with either the resin adhesive component(s) or the curing agent(s), followed by combining of the two mixtures. The plastic(s) could be mixed in with those other ingredients, but it is preferred that the plastic(s) are coated and mixed after all other ingredients have been combined and mixed together.

Regardless of the order of mixing, the resulting mixture is deposited into a form and pressed for sufficient time and pressure to form the final construction article. It will be appreciated that the mixture can be shaped into the desired size and shape depending upon the desired use. This can be accomplished by applying pressure in a form or mold presenting the desired shape and size of the final particle. Exemplary construction articles that can be formed include panels (interior and/or exterior; e.g., roof cover board, exterior sheathing, interior wall board, floor underlayment), dimensional lumber (e.g., wall studs, floor joists, planks), architectural features (e.g., arches), and/or structural members of any shape.

Typical pressures comprise about 5.5 tons (about 4,990 kg) to about 9 tons (8,165 kg), and preferably about 6 tons (5,443 kg) to about 8.5 tons (7,711 kg), over an area measuring about 14″ (35.6 cm)×16″ (40.6 cm). Typical press times are at least about 15 hours, preferably at least about 20 hours, and more preferably about 22 hours to about 30 hours. Pressing is typically carried out under ambient temperatures (e.g., 20-25° C.), unless a heat-activated adhesive is utilized. During this time, the adhesive undergoes a curing process, the mechanism of which will depend on the particular adhesive utilized, in which case the pressing temperature will be selected based on the particular heat-activated adhesive. In embodiments where an epoxy resin and curing agent are used as the adhesive, the curing agent reacts with the epoxy resin to form a cured adhesive. Regardless of the adhesive utilized, a cured adhesive network will be formed, with pieces (shreds, pellets, particles) of the particular plastic(s) interspersed among and through that network, preferably in a substantially uniform manner.

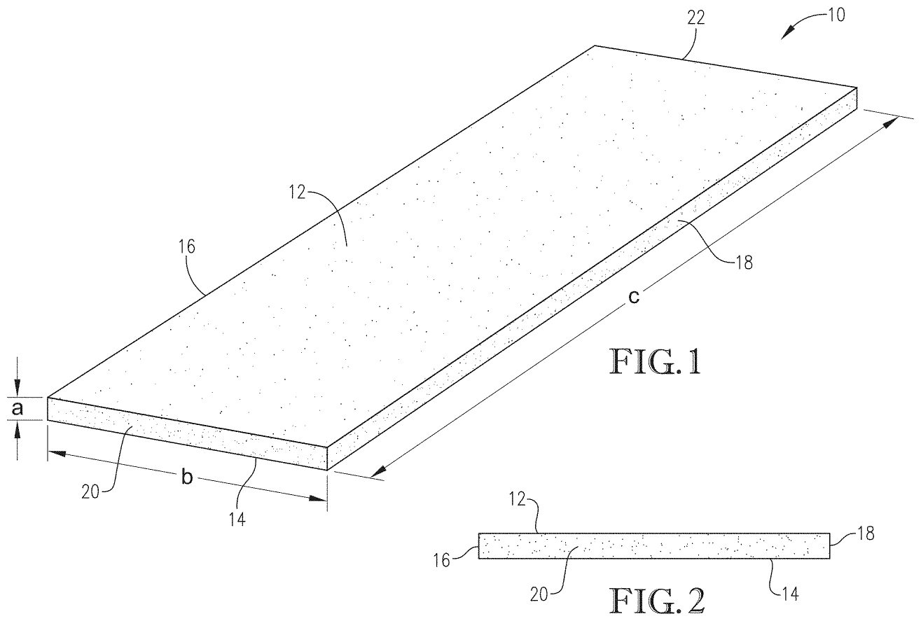

An exemplary construction article 10 formed as described herein is depicted in FIGS. 1 and 2. In the depicted embodiment, construction article 10 is a panel having six substantially planar surfaces: first and second opposing faces 12 and 14, first and second opposing sides 16 and 18, and first and second opposing ends 20 and 22. The construction article 10 defines a first transverse span or dimension “a,” also referred to as the thickness, a second transverse span or dimension “b,” also referred to as the width, and a longitudinal span or dimension “c,” also referred to as the length.

In one embodiment, construction article 10 is a non-laminated article. That is, the construction article 10 does not comprise distinct layers but only a single layer. Even more preferably, the chemical composition of construction article 10 is the same across each of dimensions “a,” “b,” and “c.” Although FIGS. 1-2 show a panel-shaped structure, construction articles formed herein will preferably also have the same chemical composition throughout and across that entire structure, from any exterior surface, face, end, etc., to any other exterior surface, face, end, etc.

Regardless, it should be noted that the panel configuration shown in the figures is shown only by way of example. The present construction articles are not limited to this particular configuration and will apply to articles having many other shapes and sizes. For example, the dimensions of thickness “a,” width “b,” and length “c” can be of any desired value, depending on the final use. In embodiments where a panel or sheathing is being formed, typical values of thickness “a” are about ¼″ (about 0.6 cm) to about ⅞″ (about 2.2 cm), and preferably about ¼″ (about 0.4 cm) to about ½″ (about 1.3 cm); typical width “b” values are about 3′ (about 0.9 m) to about 5′ (about 1.5 m), and preferably about 4′ (about 1.2 m); and typical length values “c” are about 4′ (about 1.2 m) to about 12′ (about 3.7 m), and preferably about 4′ (about 1.2 m) to about 10′ (about 3.0 m). In some embodiments, width “b” is about 4′ (about 1.2 m), length “c” is about 4′ (about 1.2 m) about 8′, or about 10′ (about 3.0 m), with thickness “a” being about ⅜″ (about 1 cm), ½″ (about 1.3 cm), or ⅝″ (about 1.6 cm).

In other embodiments, thickness “a,” width “b,” and length “c” can be selected to be that of typical dimensional lumber. For instance, the construction article 10 could be a 1″ (about 2.5 cm; “a”)×6″ (about 15.2 cm; “b”) board, a 2″ (about 2.5 cm; “a”)×4″ (about 10.2 cm; “b”) board, a 2″ (about 2.5 cm; “a”)×10″ (about 25.4 cm; “b”) board, or anything other width and/or thickness. Of course, the length (“c”) can be modified depending on the need or application, e.g., e.g., 8′ long (2.4 m), 10′ long (3 m), etc.

In still further embodiments, construction article 10 can be an irregular shape (e.g., wedge), so that the thickness of “a” varies along “b” and/or “c,” “b” varies along “a” and/or “c,” and/or “c” varies along “a” or “b.”

In some embodiments, the density of the construction article is less than about 2 g/cm³, preferably about 0.4 g/cm³ to about 2 g/cm³, more preferably about 0.4 g/cm³ to about 1.5 g/cm³, and even more preferably about 0.5 g/cm³ to about 1.1 g/cm³.

Construction articles formed as described herein preferably possess a number of physical characteristics. For example, these construction articles are high strength articles. Strength is determined by the Three-point Bend Test described in Example 4, and these construction articles will exhibit a maximum force of at least about 25 kg·f, preferably at least about 30 kg·f, and more preferably at least about 35 kg·f. The deflection at maximum force will preferably be about 13 mm to about 20 mm, and more preferably about 13 mm to about 17 mm. One or both of the foregoing maximum force and/or deflection at maximum force are preferably properties of the construction articles when tested at a thickness of about 12 mm to about 14 mm, and preferably about 13 mm.

In some embodiments, construction articles described herein will exhibit a maximum force of at least about 25 kg·f, preferably at least about 30 kg·f, more preferably at least about 35 kg·f, and even more preferably at least about 45 kg·f. The deflection at maximum force will preferably be about 10 mm to about 17 mm, and more preferably about 12 mm to about 15 mm. One or both of the foregoing maximum force and/or deflection at maximum force are preferably properties of the construction articles when tested at a thickness of about 9 mm to about 12 mm, and preferably about 11 mm.

In other embodiments, construction articles as described herein are substantially flame resistant. That is, when subjected to the Flammability Test of Example 11, these construction articles will exhibit a burn time of less than about 200 seconds, preferably less than about 150 seconds, and more preferably less than about 130 seconds.

In other embodiments, construction articles are moisture resistant, measured as described in the Moisture Resistance Test of Example 12. That is, these articles will exhibit a % moisture change of less than about 7%, preferably less than about 4%, more preferably less than about 2%, even more preferably less than about 1%, and most preferably about 0%, as defined above.

In particularly preferred embodiments, the construction articles are at least two of high strength, flame resistant, and/or moisture resistant, and most preferably are all three of high strength, flame resistant, and/or moisture resistant.

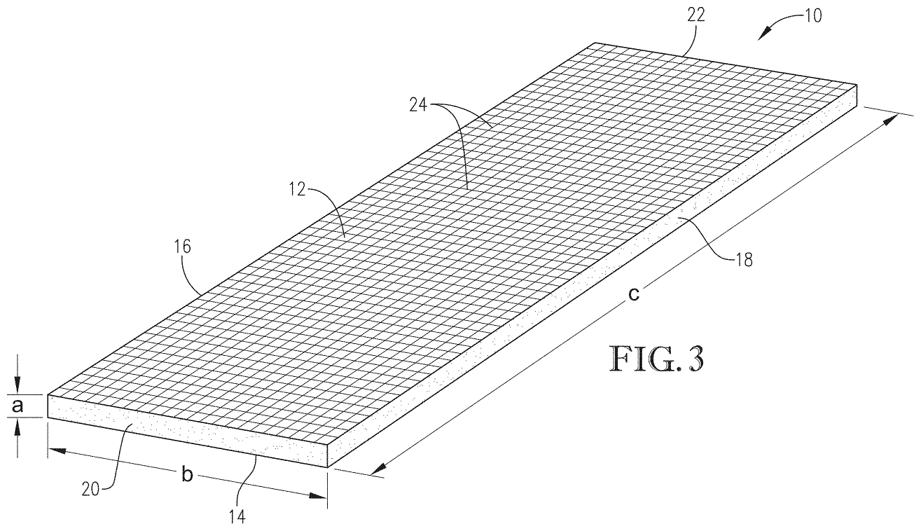

FIG. 3, where like parts receive like numbering, provides an alternative embodiment of a construction article as formed herein. In this embodiment, a fiberglass mesh layer 24 has been embedded in first opposing face 12. Although only depicted on first opposing face 12, a fiberglass mesh layer may be embedded in, or otherwise affixed to, any combination of the outer surfaces of construction article 10, including embedded in or affixed to all other outer surfaces. In some embodiments, the fiberglass coating or layer is only present on planar surfaces but not present on end and/or edge surfaces. Regardless, it is preferred that fiberglass be limited and preferably avoided within the solid body forming the construction article and only be present at the outer surfaces and/or edges, as described previously with respect to the composition used to form the construction article.

Alternatively, in some embodiments the fiberglass mesh layer 24 can instead be formed of another material, e.g., paper, insulating layer, water repellant layer (e.g., wax coating), and/or other coatings. In other embodiments, the outer surfaces of construction article 10 do not include any such coatings or layers, either with or without the previously described fiberglass mesh.

Finally, the entire description under the heading “COMPOSITION FOR FORMING CONSTRUCTION ARTICLE” applies to the final formed construction article. That is, the ingredients, specific ingredient examples, % by weight and/or ratio ranges, exclusionary language, etc., previously set forth in discussing the composition used to form the construction article are applicable to the final formed construction articles except that the adhesive is in a cured form in the final construction article. Additionally, in some embodiments, the weight ratio of total plastic to total adhesive in the final/cured construction article is about 1:0.6 to about 1:2.5, preferably about 1:0.8 to about 1:2.5, more preferably about 1:1 to about 1:2, and even more preferably about 1:1.2 to about 1:1.8.

Additional advantages of the various embodiments will be apparent to those skilled in the art upon review of the disclosure herein and the working examples below. It will be appreciated that the various embodiments described herein are not necessarily mutually exclusive unless otherwise indicated herein. For example, a feature described or depicted in one embodiment may also be included in other embodiments but is not necessarily included. Thus, the present disclosure encompasses a variety of combinations and/or integrations of the specific embodiments described herein.

As used herein, the phrase “and/or,” when used in a list of two or more items, means that any one of the listed items can be employed by itself or any combination of two or more of the listed items can be employed. For example, if a composition is described as containing or excluding components A, B, and/or C, the composition can contain or exclude A alone; B alone; C alone; A and B in combination; A and C in combination; B and C in combination; or A, B, and C in combination.

The present description also uses numerical ranges to quantify certain parameters relating to various embodiments. It should be understood that when numerical ranges are provided, such ranges are to be construed as providing literal support for claim limitations that only recite the lower value of the range as well as claim limitations that only recite the upper value of the range. For example, a disclosed numerical range of about 10 to about 100 provides literal support for a claim reciting “greater than about 10” (with no upper bounds) and a claim reciting “less than about 100” (with no lower bounds).

### EXAMPLES

The following Examples set forth methods in accordance with the disclosure. It is to be understood, however, that these Examples are provided by way of illustration, and nothing therein should be taken as a limitation upon the overall scope.

### Example 1

### Panel with Flame Retardant

The following formulation was prepared in order to test the cure compatibility and strength of a sample with wood flour as a filler material. A flame retardant, magnesium hydroxide, was incorporated to test its compatibility with curing and strength. The resins and curing agents were used as received from Arnette Polymers, LLC. Mixing was achieved by the use of a mechanical paddle mixer.

The sample was prepared by combining:
566.5 g recycled PET plastic from saved food and beverage container) that was washed with isopropyl alcohol and shredded to a size of about 4 to about 6 mm, with random occurrence of flat or crinkled strips;
457.0 g of a bisphenol F epoxy novolac resin (product of 2-(chloromethyl)oxirane, formaldehyde, and phenol; Arnette product name: SPI 7430);
151.0 g of a bisphenol A diglycidyl ether epoxy resin (product of 4,4′-(1-methylidene)bisphenol and 2-(chloromethyl)oxirane; Arnette product name: SPI 7128);
375.5 g of a modified aliphatic amine mixture (composed of 15-35 wt. % poly(propylene glycol) bis(2-aminopropyl) ether, >40 wt. % branched 4-nonylphenol, and 5-15 wt. % 1-piperazineethanamine; Arnette product name: SPI 8267);
137.5 g of an imidazoline polyamidoamine (that is composed of 95-99 wt. % fatty acid, tall-oil, reaction products with tetraethylenepentamine, and 1-5 wt. % 3,6,9-triazaundecamethylenediamine tetraethylenepentamine, Arnette product name: SPI 8055);
60.0 g magnesium hydroxide (obtained from Chemsavers, Inc.); and
160.0 g wood flour (obtained from System Three Resins, Inc.).

The two epoxy resins were mixed together thoroughly. The two amine curing agents were combined separately from the epoxy mixture and mixed thoroughly in the same manner as the epoxy mixture. Magnesium hydroxide was added to the curing agent mixture and mixed thoroughly. Wood flour was then added to this curing agent & magnesium oxide mixture followed by stirring thoroughly. The epoxy mixture was added and stirred thoroughly into the mixture containing the two amine curing agents, magnesium hydroxide, and wood flour. The resulting resin mixture was poured over the recycled PET and mixed with a mechanical paddle mixer until the PET was completely coated with the resin mixture. This was then poured into a 14″ by 16″ welded steel form that was wrapped in LDPE plastic. The sample was pressed by means of a hand-pumped hydraulic press between two steel plates (one wrapped in LDPE plastic and the other wrapped in wax paper) to a pressure of 8 tons and a sample thickness of approximately 0.5 inches. The sample was held in the press for 22 hours at ambient temperature and removed.

### Example 2

### Panel with Phenolic Microbubbles

In this Example, a formulation was prepared in order to test the cure compatibility and strength of a sample incorporating phenolic microbubbles as a flame retardant, colorant, and filler. Phenolic microbubbles were purchased from Aeromarine Products, Inc. The remaining components and their respective sources are the same as those set forth in Example 1. Mixing was achieved by the use of a mechanical paddle mixer.

The sample was prepared by combining 400.0 g recycled PET plastic that was washed with isopropyl alcohol and shredded, 380.5 g of bisphenol F novolac epoxy resin, 136.0 g of bisphenol A diglycidyl ether epoxy resin, 312.0 g of modified aliphatic amine curing agent, 118.0 g of imidazoline polyamidoamine curing agent, and 30.0 g phenolic microbubbles. The two epoxy resins were mixed together thoroughly. The amine curing agents and phenolic microbubbles all were combined and mixed thoroughly, separately from the epoxy resin mixture. The epoxy resin mixture and the amine curing agent mixture were then combined and mixed thoroughly followed by pouring over the recycled PET plastic. This combination was then mixed to ensure complete coating of the PET plastic, and the resulting mixture was placed in the steel form described above. This sample was pressed under 6 tons, again to a sample thickness of approximately 0.5 inches. The sample was held in the press for 26 hours under ambient conditions and then removed from the press.

### Example 3

### Panel with Single Epoxy Resin

In this Example, a single epoxy resin was utilized, and the weight ratio of epoxy resin to amine curing agent was altered. All components and their respective sources were the same as those set forth in Example 2 Mixing was achieved by the use of a mechanical paddle mixer.

The sample was prepared by combining 708.4 g recycled PET plastic that was washed with isopropyl alcohol and shredded, 495.5 g of bisphenol F novolac epoxy resin, 410.5 g of modified aliphatic amine curing agent, 141.5 g of imidazoline polyamidoamine curing agent, and 57.0 g phenolic microbubbles. The two amine curing agents and phenolic microbubbles were combined and mixed thoroughly. The epoxy resin and the amine curing agent mixture were then combined and mixed thoroughly followed by pouring over the recycled PET plastic. This combination was then mixed to ensure complete coating of the PET plastic, and the resulting mixture was placed in the steel form described above. This sample was pressed under 7 tons, again to a sample thickness of approximately 0.5 inches. The sample was held in the press for 26 hours under ambient conditions and then removed from the press.

### Example 4

### Strength Testing

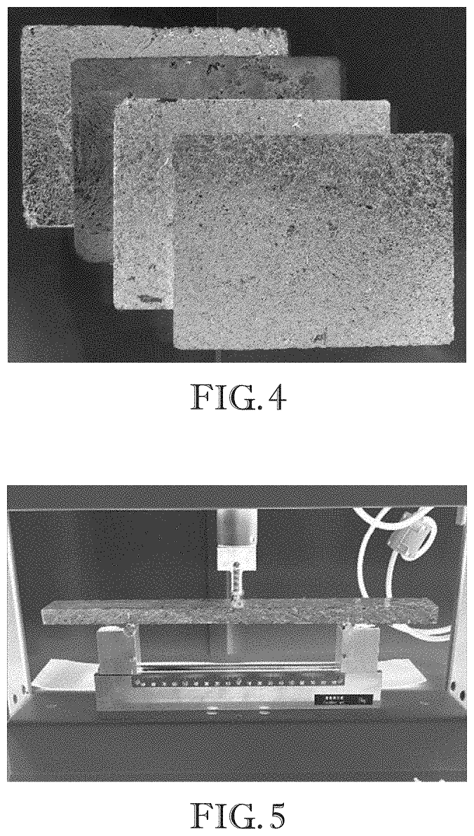

FIG. 4 shows exemplary 2″ (30.48 cm)×16″ (40.64 cm) prototype panels that were prepared and tested as described herein. The respective strengths (stiffnesses) of samples cut from the Examples 1-3 prototype panels were determined using the three-point bend of ASTM standard D3043-17, but varied as explained herein. The span between the supporting pins was 20 cm, with the load being applied at the center point, as shown in FIG. 5. These test samples were cut from different areas of the prototype panel using standard woodworking tools. Each test sample was 2 inches (5.1 cm) by 14 inches (35.6 cm).

Table 1 shows the results from this testing. The mean force was 78.7 lb·ft (+/−7.19 lb·ft) at a mean deflection at maximum force of 17.4 mm (+/−) 5.41 mm. FIGS. 4 and 5 also illustrate the non-laminated structure previously noted. Additionally, one can observe the presence of a uniform material across the dimensions of the produced test sample. That is, the formed sample is formed of the same chemical composition across its entire structure or body.

TABLE 1
Strength Test Data

| | Avg. Sample | | | Deflection at |
|---|---|---|---|---|
| | Thickness | Max. Force | | Max. Force |
| Sample ID | (mm) | (kg · f) | (lb · f) | (mm) |
| Example 3(a) | 13.91 | 35.4 | 78.1 | 15.0 |
| Example 3 (b) | 14.09 | 43.5 | 95.9 | 27.3 |
| Example 3(c) | 13.89 | 34.8 | 76.8 | 26.4 |
| Example 1(a) | 11.28 | 34.5 | 76.1 | 15.4 |
| Example 1(b) | 11.81 | 32.7 | 72.1 | 13.7 |
| Example 1(c) | 11.35 | 35.0 | 77.2 | 14.8 |
| Example 2(a) | 12.84 | 37.1 | 81.8 | 14.2 |
| Example 2(b) | 12.43 | 35.7 | 78.7 | 16.4 |
| Example 2(c) | 12.42 | 32.4 | 71.5 | 13.7 |
| | mean | 35.7 | 78.7 | 17.4 |
| | std. dev. (+/−) | 3.27 | 7.19 | 5.41 |

### Example 5

### Panel with Increased PET

In this Example, a formulation was prepared in order to test the effect of a higher percentage of recycled PET plastic. The components and their respective sources are the same as those set forth in Example 2. Mixing was achieved by the use of a mechanical paddle mixer.

The sample was prepared by combining 560 g recycled PET plastic that was washed with isopropyl alcohol and shredded, 495.0 g of bisphenol F novolac epoxy resin, 170.0 g of bisphenol A diglycidyl ether epoxy resin, 353.0 g of modified aliphatic amine curing agent, 142.0 g of imidazoline polyamidoamine curing agent, and 50.0 g phenolic microbubbles. The two epoxy resins were mixed together thoroughly for 3 minutes. The amine curing agents and phenolic microbubbles were combined and mixed thoroughly, separately from the epoxy resin mixture. The epoxy resin mixture and the amine curing agent mixture were then combined and mixed thoroughly for 3 minutes followed by pouring over the recycled PET plastic. This combination was then mixed to ensure complete coating of the PET plastic, and the resulting mixture was placed in the steel form described previously. This sample was pressed under 7 tons, again to a sample thickness of approximately 0.5 inches. The sample was held in the press for 23 hours under ambient conditions and then removed from the press. The final sample was found to have a mass of 1,377 g, a decrease of 393 g of the total weight of all starting components. This decrease was attributable to some of the adhesive (i.e., epoxy resin plus amine curing agent) seeping from the form during pressing. Thus, rPET (i.e., recycled PET) was present in the final sample at 40.7% by mass.

### Example 6

### Panel Without Filler

In this Example, a formulation was prepared in order to test the effect of using no filler. The components and their respective sources are the same as those set forth in Example 1. Mixing was achieved by the use of a mechanical paddle mixer.

The sample was prepared by combining 560 g recycled PET plastic that was washed with isopropyl alcohol and shredded, 495.0 g of bisphenol F novolac epoxy resin, 170.5 g of bisphenol A diglycidyl ether epoxy resin, 353.0 g of modified aliphatic amine curing agent, and 142.0 g of imidazoline polyamidoamine curing agent. The two epoxy resins were mixed together thoroughly for 3 minutes. The two amine curing agents were combined and mixed thoroughly, separately from the epoxy resin mixture. The epoxy resin mixture and the amine curing agent mixture were then combined and mixed thoroughly for 3 minutes followed by pouring over the recycled PET plastic. This combination was then mixed to ensure complete coating of the PET plastic, and the resulting mixture was placed in the steel form described previously. This sample was pressed under 8.5 tons, again to a sample thickness of approximately 0.5 inches. The sample was held in the press for 23 hours under ambient conditions and then removed from the press. When removed from the press the sample was found to have several voids.

### Example 7

### Panel with Fumed Silica and Fiberglass Mesh Reinforcement

In this Example, the effects of incorporating fumed silica as a filler and of employing a fiberglass mesh reinforcement was tested. The resins, curing agents, and their respective sources were the ones described in Example 1. Fumed silica (CAB-O-SIL® Silica-34) was obtained from The Epoxy Resin Store and was used as received. Fiberglass mesh (by Clark Schwebel FiberGlass) was used as received. Mixing was achieved by the use of a mechanical paddle mixer.

The sample was prepared by combining 560 g recycled PET plastic that was washed with isopropyl alcohol and shredded, 496.5 g of bisphenol F novolac epoxy resin, 170.5 g of bisphenol A diglycidyl ether epoxy resin, 353.0 g of modified aliphatic amine curing agent, 142.0 g of imidazoline polyamidoamine curing agent, and 351 mL fumed silica (dry volume, which is about 814 g). The two epoxy resins were mixed together thoroughly for 3 minutes. The two amine curing agents were combined and mixed thoroughly, separately from the epoxy resin mixture. The fumed silica was then added to the amine curing agent mixture followed by stirring for 3 minutes. The epoxy resin mixture and the amine curing agent mixture (which now also contained the fumed silica) were then combined and mixed thoroughly for 3 minutes followed by pouring over the recycled PET plastic. This combination was then mixed to ensure complete coating of the PET plastic. One layer of fiberglass mesh was placed in the bottom of the previously described form, the resin-coated PET plastic was layered on top of that fiberglass mesh, and another layer of fiberglass mesh was placed on top of the resin/PET mixture. This sample was pressed under 8 tons, again to a sample thickness of approximately 0.5 inches. The sample was held in the press for 28 hours under ambient conditions and then removed from the press. When removed from the press the sample appeared to be much more tough and rigid than other prior samples.

### Example 8

### Panel with Plastics Variety

This Example was similar to Example 7 in that fumed silica and fiberglass mesh reinforcement layers were utilized, however a wide variety of recyclable plastics were used to simulate plastics at a large-scale recycling facility. The post-consumer plastics included the “Big Six” heavy-use recyclable plastics: PET plastic (from food containers), polypropylene (from food containers), polyvinyl chloride plastic (from house siding), high-density polyethylene from food containers, low-density polyethylene (from food containers), and polystyrene (from food containers). All other components were as described in Example 1. Again, mixing was achieved using a mechanical paddle mixer.

The sample was prepared by combining 560 g the above-described variety of recycled plastics (washed with isopropyl alcohol and shredded), 496.0 g of bisphenol F novolac epoxy resin, 171.0 g of bisphenol A diglycidyl ether epoxy resin, 353.0 g of modified aliphatic amine curing agent, 142.0 g of imidazoline polyamidoamine curing agent, and 350 mL fumed silica (dry volume, which is about 814 g). The two epoxy resins were mixed together thoroughly for 3 minutes. The two amine curing agents were combined and mixed thoroughly, separately from the epoxy resin mixture. The fumed silica was then added to the amine curing agent mixture followed by stirring for 3 minutes. The epoxy resin mixture and the amine curing agent mixture (which now also contained the fumed silica) were then combined and mixed thoroughly for 3 minutes followed by pouring over the recycled PET plastic. This combination was then mixed to ensure complete coating of the PET plastic. One layer of fiberglass mesh was placed in the bottom of the previously described form, the resin-coated PET plastic was layered on top of that fiberglass mesh, and another layer of fiberglass mesh was placed on top of the resin/PET mixture. This sample was pressed under 8 tons, again to a sample thickness of approximately 0.5 inches. The sample was held in the press for 23 hours under ambient conditions and then removed from the press. When removed from the press, the sample appeared to be somewhat more brittle than the Example 7 sample.

### Example 9

### Strength Testing

Strength testing was carried out as described in Example 4 above. Table 2 shows the results from this testing.

TABLE 2
Strength Test Data

| | Avg. Sample | | | Deflection at |
|---|---|---|---|---|
| | Thickness | Max. Force | | Max. Force |
| Sample ID | (mm) | (kg · f) | (lb · f) | (mm) |
| Example 5(a) | 10.58 | 25.2 | 55.4 | 12.8 |
| Example 5(b) | 11.73 | 30.4 | 66.9 | 10.9 |
| Example 5(c) | 10.47 | 28.5 | 62.6 | 14.0 |
| Example 6(a) | 9.91 | 23.6 | 52.0 | 12.5 |
| Example 6(b) | 10.02 | 26.9 | 59.1 | 13.2 |
| Example 6(c) | 10.36 | 26.9 | 59.1 | 12.4 |
| Example 7(a) | 11.65 | 55.1 | 121.2 | 10.8 |
| Example 7(b) | 11.39 | 41.5 | 91.3 | 11.5 |
| Example 7(c) | 10.85 | 46.0 | 101.1 | 12.3 |
| Example 8(a) | 11.96 | 47.5 | 104.6 | 14.5 |
| Example 8(b) | 11.09 | 36.9 | 81.2 | 14.2 |
| Example 8(c) | 11.04 | 26.1 | 57.5 | 12.2 |
| | mean | 34.5 | 76.0 | 12.6 |
| | std. dev. (+/−) | 10.6 | 23.2 | 1.2 |

### Example 10

### Workability Testing

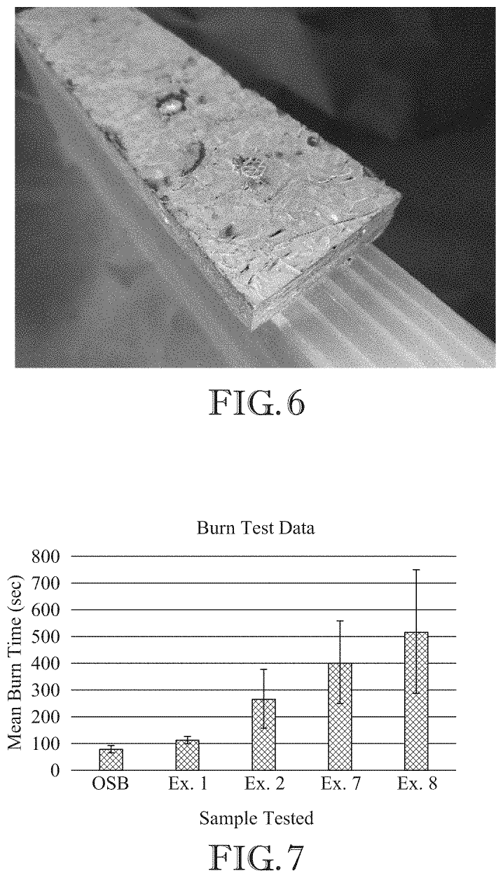

This Example was carried out to verify panels made as described herein were workable with standard woodworking tools. In order to test the workability of the prototype, a sample similar to Example 2 was cut using a power table saw, cut using a power miter saw, nailed with a 20-oz (28.3-g) hammer, and screwed with a drill to a standard 2″ (5.08 cm)×4″ (10.2 cm) construction board (see FIG. 6).

### Example 11

### Flammability Testing

Flammability tests of samples was conducted following ASTM-D635, varied as described herein. OSB plywood samples were obtained from Lowe's Home Improvement and were used as received immediately after purchase. Samples were cut to 2″ (5.1 cm) wide and between 7/16″ (1.1 cm) and ½″ (1.3 cm) thick. The samples were then marked at a distance of 100 mm from the end to which a flame would be applied (“Test End”). The samples were held horizontally on a stand, and a blue flame from a propane gas torch was applied to the Test End of the sample for 30 seconds. Following removal of the torch, the samples were allowed to burn, and the time over which a flame was supported was observed and recorded. The maximum distance over which the flame spread across the top surface of the samples was also recorded. If a sample had flame spreading that reached the 100-mm mark, the test was stopped and the flame was extinguished. Tests were conducted in triplicate for each sample. The results of the flame testing are given in Table 3. The mean burn time of each triplicate is shown in FIG. 7.

TABLE 3
Flammability Test Data

| | | | | Std. | | Std. |
|---|---|---|---|---|---|---|
| | | | | Dev. | | Dev. |
| | Burn | Flame | Mean | Time | Mean | Travel |
| | Time | Travel | time | (+/− | Travel | (+/− |
| Sample | (sec) | (mm) | (sec) | sec) | (mm) | mm) |
| OSB-1 | 88.51 | 2 | | | | |
| OSB-2 | 62.75 | 8 | 77.60 | 13.33 | 8 | 6 |
| OSB-3 | 81.55 | 13 | | | | |
| Example 1(a) | 111.05 | 58 | | | | |
| Example 1(b) | 99.48 | 17 | 112.01 | 13.03 | 35 | 21 |
| Example 1(c) | 125.49 | 29 | | | | |
| Example 2(a) | 392.99 | 64 | | | | |
| Example 2(b) | 197.36 | 7 | 267.62 | 108.84 | 45 | 33 |
| Example 2(c) | 212.5 | 64 | | | | |
| Example 7(a) | 309.39 | 21 | | | | |
| Example 7(b)* | 580.34 | 67 | 402.20 | 154.32 | 37 | 26 |
| Example 7(c) | 316.86 | 23 | | | | |
| Example 6(a)* | 595.48 | >100 | | | | |
| Example 6(b)* | 258.37 | >100 | 517.58 | 230.36 | | |
| Example 6(c)* | 698.88 | >100 | | | | |

*Sample dripped in portions that continued burning.

As indicated in Table 3, the samples incorporating wood flour filler and magnesium hydroxide as flame-retardant (Example 1(a)-1(c)) exhibited mean burn times that were longer than the OSB plywood samples, but significantly shorter than the samples with no flame-retardant (Examples 6(a)-6(c)).

### Example 12

### Moisture Resistance Testing

Water uptake tests were conducted on prepared samples as a measure of the moisture resistance. Samples to be tested were cut to 2″ (5.1 cm) by 6″ (15.2 cm). The OSB plywood samples were obtained from Lowe's Home Improvement and were used as received immediately after purchase. The mass and percent moisture of samples were measured before and after the samples were fully submerged in water for 24 hours at ambient temperature. The water was obtained from a tap and its temperature was measured periodically during the test and was 66° F. (19° C.) throughout the test. After 24 hours, the samples were removed from the water and thoroughly blotted dry with a paper towel. The samples were then allowed to air dry for one hour at a temperature of 66.6° F. (19.2° C.) Masses were measured using an electronic balance. The balance was calibrated according to manufacturer instructions prior to use. All samples were tested in triplicate. The results of the moisture resistance testing are given in Table 4, where % Mass Change corresponds to moisture uptake by the particular sample.

TABLE 4
Moisture Resistance Test Data

| | | | | Mean | Mass |
|---|---|---|---|---|---|
| | Pre- | Post- | % | Mass | Change |
| | Soak | Soak | Mass | Change | Std. |
| | Mass | Mass | Change | % | Dev. |
| Sample | (g) | (g) | (%) | (%) | (+/−%) |
| OSB-1 | 54.75 | 69.96 | 27.78 | | |
| OSB-2 | 50.68 | 62.14 | 22.61 | 24.57 | 1.66 |
| OSB-3 | 52.94 | 65.28 | 23.31 | | |
| Example 5(a) | 82.72 | 82.91 | 0.23 | | |
| Example 5(b) | 89.78 | 89.83 | 0.06 | 0.16 | 0.00 |
| Example 5(c) | 84.87 | 85.04 | 0.20 | | |
| Example 6(a) | 89.19 | 89.55 | 0.40 | | |
| Example 6(b) | 84.93 | 85.15 | 0.26 | 0.30 | 0.00 |
| Example 6(c) | 85.76 | 85.97 | 0.24 | | |
| Example 7(a) | 101.15 | 101.16 | 0.01 | | |
| Example 7(b) | 98.16 | 98.18 | 0.02 | 0.06 | 0.00 |
| Example 7(c) | 103.52 | 103.69 | 0.16 | | |

As indicated in Table 4, the samples prepared according to this disclosure exhibited very little moisture uptake under the test conditions as compared to commercially available OSB plywood. All OSB samples had a significantly higher percent moisture content than the prepared samples. These data demonstrate the superior moisture resistance of the inventive panels as compared to commercially available OSB plywood.

1. A construction article comprising an adhesive network having pieces of plastic interspersed among said adhesive network.

2. The construction article of claim 1, wherein said construction article is a solid body having a chemical composition that is the same throughout said solid body.

3. The construction article of claim 1, wherein said plastic comprises a post-consumer recycled plastic.

4. The construction article of claim 1, wherein said plastic comprises polyethylene terephthalate, high-density polyethylene, polyvinyl chloride, low-density polyethylene, polypropylene, polystyrene, or mixtures thereof.

5. The construction article of claim 1, wherein said adhesive network comprises a cured epoxy adhesive.

6. The construction article of claim 1, wherein one of the following is true:
(i) the total plastic included in said construction article comprises less than about 50% by weight low-density polyethylene;
(ii) said construction article comprises less than about 40% by weight cellulose;
(iii) said construction article comprises a solid body presenting an interior and outer surfaces, said solid body comprising less than about 1% by weight fiberglass in the interior of said solid body;
(iv) both (i) and (ii);
(v) both (ii) and (iii);
(vi) both (ii) and (iii); or
(vii) each of (i)-(iii).

7. The construction article of claim 1, wherein said construction article is in the form of a panel or board.

8. The construction article of claim 7, said construction article having first and second opposing surfaces, there being a fiberglass mesh layer embedded in, or affixed to, at least one of said first and second opposing surfaces.

9. The construction article of claim 7, said construction article having first and second opposing surfaces without a paper coating, water repellant coating, or insulating layer on either of said first or second opposing surfaces.

10. The construction article of claim 1, wherein:
said construction article comprises about 10% by weight to about 55% by weight plastic, based on the total weight of the construction article;
at least about 50% by weight of said plastic comprises recycled PET plastic;
said construction article comprises about 30% by weight to about 85% by weight adhesive, based on the total weight of the construction article; and
said construction article further comprises an ingredient chosen from flame retardants, fillers, or mixtures thereof.

11. The construction article of claim 10, wherein said adhesive comprises an epoxy resin adhesive cured by an amine curing agent, and said ingredient is chosen from magnesium hydroxide, phenolic microbubbles, fumed silica, or mixtures thereof.

12. The construction article of claim 1, wherein said construction article consists essentially of said plastic, said adhesive network, and an ingredient chosen from flame retardants, fillers, colorants, or mixtures thereof.

13. The construction article of claim 1, wherein said plastic comprises discrete pieces interspersed among said adhesive network.

14. The construction article of claim 1, wherein said plastic is in the form of shreds, pellets, powder, or mixtures thereof.

15. The construction article of claim 13, said pieces having an average maximum dimension of about 10 mm or less.

16. The construction article of claim 1, wherein said construction article is non-laminated.

17. A construction method comprising securing a construction article according to claim 1 to a frame of a building.

18. The construction method of claim 17, wherein said construction article is secured to a roof, wall, or floor.

19. A building structure comprising a plurality of construction articles according to claim 1 coupled to a plurality framing members.

20. The building structure of claim 19, wherein said plurality of framing members are part of a roof, wall, or floor.
